(19) United States
(12) Patent Application Publication
(10) Pub. No.: US 2003/0130154 A1
(43) Pub. Date: Jul. 10, 2003

(54) Detergent compositions

(75) Inventors: Philippus Cornelis Van Der Hoeven, Vlaardingen (NL); Harriet Frederique Hommes, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/330,813

(22) Filed: Dec. 27, 2002

(30) Foreign Application Priority Data
Dec. 28, 2001 (GB) 0131055.6

(51) Int. Cl. C11D 17/00

(52) U.S. Cl. 510/439; 510/445; 510/499

(57) ABSTRACT

A water soluble package formed from a water soluble film containing a substantially non-aqueous liquid composition comprising at least one surfactant selected from those of formula (I):

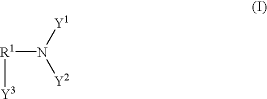

wherein R¹ is a straight or branched C₅-C₂₂ alkyl or C₅-C₂₂ alkenyl group, preferably C₅-C₁₈ alkyl group or C₅-C₁₈ alkenyl group, or a group of formula

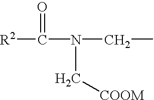

wherein R² is independently selected from groups defined for R¹ above;

Y¹ and Y² are independently selected from groups of formula

—(AO)ₙ—(CH₂)ₘ—CO₂M;

wherein each AO is an independently selected C₂-C₄, preferably C₂ or C₃ alkyleneoxy group, n is on average from 0 to 20, preferably from 0-10, still more preferably from 1 to 3;

m is from 0 to 5, preferably from 1 to 3, preferably n+m being at least 1;

M is a hydrogen ion or a cation, preferably an organic cation or an alkali metal ion; and Y³ is hydrogen or an independently selected group of formula Y¹ and Y² as hereinbefore defined.

### FIELD OF THE INVENTION

The present invention relates to detergent compositions.

### BACKGROUND OF THE INVENTION

Detergent compositions for the washing of textile fabrics usually contain one or more anionic and/or nonionic surfactants. The most commonly used kind of nonionic surfactants are ethoxylated fatty alcohols.

The most common anionic surfactant used in compositions for the washing of textile fabrics are (linear) alkylbenzene sulphonates (LAS).

Recently, laundry wash compositions have been sold in so-called liquid unit dose form. Although there are many speculative disclosures of possible formulations, invariably market products are in the form of water soluble sachets which are formed of a film which is a copolymer of vinyl alcohol and another comonomer. In the following text, generically, such films will be termed “PVA” films, although other polymer technologies are possible.

The formulation in such commercial PVA film sachets is a substantially non-aqueous liquid detergent composition comprising a liquid nonionic surfactant, a cosolvent such as a glycol, an alkylbenzene sulphonate anionic surfactant and a “soap”. The anionic surfactant and “soap” usually have an organic counter cation such as monoethanolamine, which is usually present in excess of the amount required to neutralise the alkylbenzene sulphonic acid and fatty acid. These formulation constraints are a result of the need for compatibility with the film used to form the sachets.

These compositions are usually also devoid of strong detergency builders such as aluminosilicates or phosphates. As a result, such products tend to have problems in removal of “difficult” soils and stains, especially in hard water areas.

We have now found that by replacing all or part of the anionic surfactant with one or more of the certain class of di- or tri-carboxy tertiary amine surfactants, this drawback can be avoided.

Di(alkoxycarboxy) tertiary amine surfactants in which the third alkoxycarboxy group is substituted on the hydrophobe carbon adjacent the nitrogen atom are disclosed as components of detergent compositions in EP-A-0 881 280, U.S. Pat. Nos. 6,235,704, 6,225,278 and 5,994,290. However, special suitability for liquid unit dose applications is not disclosed.

### DEFINITION OF THE INVENTION

Thus, the present invention provides a water soluble package formed of a water soluble film containing a substantially non-aqueous liquid composition comprising at least one surfactant of formula (I):

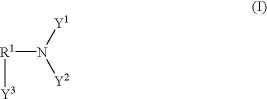

wherein R¹ is a straight or branched C₅-C₂₂ alkyl or C₅-C₂₂ alkenyl group, preferably C₅-C₁₈ alkyl group or C₅-C₁₈ alkenyl group, or a group of formula

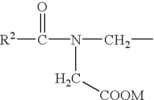

wherein R² is independently selected from groups defined for R¹ above;

Y¹ and Y² are independently selected from groups of formula

—(AO)ₙ—(CH₂)ₘ—CO₂M;

wherein each AO is an independently selected C₂-C₄, preferably C₂ or C₃ alkyleneoxy group, n is on average from 0 to 20, preferably from 0-10, still more preferably from 1 to 3;

m is from 0 to 5, preferably from 1 to 3, preferably n+m being at least 1;

M is a hydrogen ion or a cation, preferably an organic cation or an alkali metal ion; and Y³ is hydrogen or an independently selected group of formula Y¹ and Y² as hereinbefore defined.

### DETAILED DESCRIPTION OF THE INVENTION

As used herein, unless specifically indicated to the contrary, the terms alkyl and alkenyl cover both straight and branched forms.

The Surfactant of Formula (I)

In one preferred class of embodiments, in both Y¹ and Y², n is zero and preferably, m is 2, and Y³ is hydrogen.

In another preferred class of embodiments, in each of Y¹ and Y², n is on average 3 or higher and m is 1, and Y³ is hydrogen.

In a third preferred class of embodiments, in both Y¹ and Y², n is zero, m is 2 and in Y³, both m and n are zero.

In a fourth class of embodiments, in both Y¹ and Y², n is zero, m is 1, Y³ is hydrogen and R¹ is a group of formula R²CON(CH₂COOM)CH₂.

In each of the first to fourth preferred classes of embodiments, preferably R¹ and R², as appropriate, are C₅-C₁₈ alkyl or alkenyl.

Preferably, the amount of surfactant of formula (I) is from 0.1% to 80%, more preferably from 1% to 60%, still more preferably from 2% to 50% and most preferably from 3% to 40% by weight of the total substantially non-aqueous liquid composition.

Of the total non-anionic surfactant in the composition that of formula (I) represents from 0.1% to 100%, more preferably from 2% to 80%, even more preferably from 5% to 60% and most preferably from 10% to 50% by weight.

Some preferred specific structures of formula (I) are:

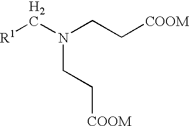

where p and q are independently ≧3.

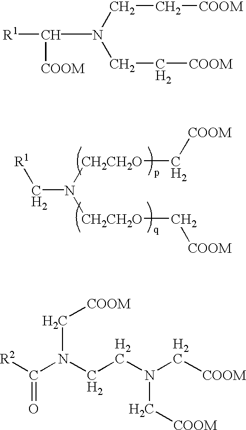

In these preferred specific structures, R¹ and R² are independently C₈-C₁₈ alkyl or C₈-C₁₈ alkenyl, especially C₁₂-C₁₈ alkyl or C₁₆-C₁₈ alkenyl and M is hydrogen or sodium.

The Water Soluble Sachet

The envelope forming the package is preferably formed by horizontal or vertical form-film-seal technique.

(a) The Water Soluble Polymer Film

As used herein, the term “water soluble polymer” refers to a polymer which dissolves and/dispensers completely in water within 30 minutes with agitation, e.g. by means of hand, stick or other stirrer or under the action of a mechanical washing machine and at a relevant temperature. A “relevant temperature” is one at which the consumer will need to dissolve or disperse the polymer component at the beginning of, or during a cleaning process. A polymer is to be regarded as dissolving or dispersing at a “relevant temperature” if it does so under the aforementioned conditions at a temperature anywhere in the range of from 20° C. to 60° C.

Preferred water soluble polymers are those capable of being cast into a film or solid mass and may for example as described in Davidson and Sittig, Water-Soluble Resins, Van Nostrand Reinhold Company, New York (1968). The water-soluble polymer should have proper characteristics, such as strength and heat-sealability, to permit machine handling during the processes of making the water soluble package. Preferred water-soluble resins include polyvinyl alcohol, cellulose ethers, polyethylene oxide, starch, polyvinylpyrrolidone, polyacrylamide, polyvinyl methyl ether-maleic anhydride, polymaleic anhydride, styrene maleic anhydride, hydroxyethylcellulose, methylcellulose, polyethylene glycols, carboxymethylcellulose, polyacrylic acid salts, alginates, acrylamide copolymers, guar gum, casein, ethylene-maleic anhydride resin series, polyethyleneimine, ethyl hydroxyethylcellulose, ethyl methylcellulose, hydroxyethyl methylcellulose. Lower molecular weight water-soluble, polyvinyl alcohol film-forming resins are preferred.

Polyvinyl alcohols preferred for use therein have an average molecular weight anywhere between 1,000 and 100,000, preferably between 5,000 and 250,000, for example between 15,000 and 150,000. Hydrolysis, or alcoholysis, is defined as the percent completion of the reaction where acetate groups on the resin are substituted with hydroxyl, —OH, groups, A hydrolysis range of from 60-99% of polyvinyl alcohol film-forming resin is preferred, while a more preferred range of hydrolysis is from about 70-90% for water-soluble, polyvinyl alcohol film-forming resins. The most preferred range of hydrolysis is 80-89%. As used in this application, the term “polyvinyl alcohol” includes polyvinyl acetate compounds with levels of hydroloysis disclosed herein. The water-soluble resin film should be formulated so as to substantially completely dissolve in 50° C. water with agitation within about thirty minutes, preferably within about 15 minutes in 50° C. water with agitation, and most preferably within about 5 minutes in 50° C. water with agitation.

An especially preferred plastics film is a polyvinyl alcohol film, made of a polyvinyl alcohol copolymer having a comonomer having a carboxylate function.

PVA can be made by the polymerisation of vinyl acetate, followed by hydrolysis, conveniently by reaction with sodium hydroxide. However, the resulting film has a highly symmetrical, hydrogen-bonded structure and is not readily soluble in cold water. PVA films which are suitable for the formation of water soluble packages are typically polymers produced from copolymerisation of vinyl acetate and another comonomer which contains a carboxylic function. Examples of such comonomers include monocarboxylates, such as acrylic acid, and dicarboxylates, such as itaconic acid, which may be present during polymerisation as esters. Alternatively, the anhydride of maleic acid may be used as the copolymer. The inclusion of the comonomer reduces the symmetry of and degree of hydrogen bonding in the final film and renders the film soluble even in cold water.

Suitable PVA films for use in a package according to the invention are commercially available and described, for example, in EP-B-0 291 198. PVA films for use in a package according to the invention can be made by the copolymerisation of vinyl acetate and a carboxylate-containing monomer (for example acrylic, maleic or itaconic acid or acid ester), followed by partial (for example up to about 90%) hydrolysis with sodium hydroxide.

The film may incorporate a plasticiser.

As will be elucidated in more detail hereinbelow, the water soluble film may be formed from a variety of different materials. The plasticiser will depend on the nature of the film in question. Preferred plasticisers are recited in more detail in the section of this description dealing with these film materials. One or more plasticisers may independently be incorporated in the film and in the liquid composition. However, it is very much preferred for the identity of the plasticiser(s) in the film and in the liquid composition to be substantially the same.

The plasticiser system influences the way the polymer chains react to external factors such as compression and extensional forces, temperature and mechanical shock by controlling the way that the chains distort/realign as a consequences of these intrusions and their propensity to revert or recover to their former state. The key feature of preferred plasticisers is that they are highly compatible with the film, and are normally hydrophilic in nature.

Generally speaking, plasticisers suitable for use with PVA-based films have —OH groups in common with the ˜CH2—CH(OH)—CH2—CH(OH)-polymer chain of the film polymer.

Their mode of functionality is to introduce short chain hydrogen bonding with the chain hydroxyl groups and thus weaken adjacent chain interactions which inhibits swelling of the aggregate polymer mass—the first stage of film dissolution.

Water itself is a suitable plasticiser for any of the films recited herein but other common plasticisers include:

Polyhydroxy compounds, e.g. glycerol, trimethylolpropane, diethylene glycol, triethylene glycol, dipropylene glycol;

Starches e.g. starch ether, esterificated starch, oxidized starch and starches from potato, tapioca and wheat;

Cellulosics/carbohydrates, e.g. amylopectin, dextrin carboxymethylcelluose and pectin.

The amount of plasticiser per unit weight of film may vary considerably according to the film type and plasticiser type(s). It could, for example be in the range of from 0.1% to 50%, e.g. 10% to 45%, such as 20% to 40% by weight.

Polyvinylpyrrolidone is (PVP), another preferred polymer for use in the articles of the present invention. Dried, unmodified films of PVP are clear or transparent, glossy and reasonably hard. Modifiers may be used in concentrations of 10 to 50% to control tack, brittleness or to decrease the hygroscopicity. Unmodified PVP films are relatively very hygroscopic in character, and moisture taken up from the air can also act as plasticiser. Other plasticisers are for example glycerol, propylene glycol, diethylene glycol and sorbitol. These tend to increase tackiness of the PVP film. Carboxymethylcellulose or cellulose acetate can be used to decrease tackiness. Films essentially tack-free over all ranges of relative humidity may be also obtained by incorporation of 10% arylsulfonamide-formaldehyde resin.

Preferred water-soluble films may also be prepared from polyethylene oxide (PEO). High molecular weight polymers of ethylene oxide with molecular weight of about 100,000 to 5,000,000 form strong, translucent, thermoplastic films. Unfunctionalised films of these resins easily crack when only minor stress is applied (a process known as ‘stress cracking’). This is accelerated by exposure to ultraviolet radiation but can be slowed down or inhibited completely by the addition of plasticisers in combination with suitable UV radiation inhibitors. Suitable plasticisers are for example (low molecular weight) polyethylene glycol and polypropylene glycol, carbohydrates, glycerol, organic and inorganic esters such as glycerol triacetate or triethyl citrate.

PEO films generally have very good mechanical properties and heat sealability, combined with complete water solubility. In comparison with other commonly used water-soluble films, polyethylene oxide films offer the advantage of good compatibility.

Further examples of suitable water soluble polymers are modified celluloses, such as methylcellulose (MC) and hydroxypropylmethylcellulose (HPMC). These yield high-strength, clear, water-soluble films that are impervious to many organic and petroleum-based solvents. The mechanical properties can be modified by a number of plasticisers, such as glycerol, propylene glycol, sorbitol, diethylene glycol, triethanol amine, and N-acetyl ethanol amine. Properly plasticised MC or HPMC sheeting products can be sealed at about 130° C. using standard sealing equipment.

An alternative cellulose-based material is hydroxypropyl cellulose (HPC). Clear, flexible films of this material may be prepared from aqueous or organic solvent solutions of the polymer. An advantage of HPC is that it has good plastic-flow properties enabling it to be thermoformed into flexible film articles without the aid of plasticisers or other additives. They are non-tacky even at high humidity. The unplasticised film has good cold water solubility but is insoluble in water >45° C.

All of the above polymers include the aforementioned polymer classes whether as single polymers or as copolymers formed of monomer units or as copolymers formed of monomer units derived from the specified class or as copolymers wherein those monomer units are copolymerised with one or more comonomer units.

Blends (i.e. not copolymers) of two or more polymers recited herein, may also be used.

Encapsulation Methods

(a) Horizontal Form-Fill-Seal

Water soluble based on PVA can be made according to any of the methods horizontal form-fill-seal described in any of WO-A-00/55044, WO-A-00/55045, WO-A-00/55046, WO-A-00/55068, WO-A-00/55069 and WO-A-00/55415.

By way of example, a thermoforming process is now described where a number of packages according to the invention are produced from two sheets of water soluble material. In this regard recesses are formed in the film sheet using a forming die having a plurality of cavities with dimensions corresponding generally to the dimensions of the packages to be produced. Further, a single heating plate is used for thermoforming the film for all the cavities, and in the same way a single sealing plate is described.

A first sheet of polyvinyl alcohol film is drawn over a forming die so that the film is placed over the plurality of forming cavities in the die. In this example each cavity is generally dome shape having a round edge, the edges of the cavities further being rounded to remove any sharp edges which might damage the film during the forming or sealing steps of the process. Each cavity further includes a raised surrounding flange. In order to maximise package strength; the film is delivered to the forming die in a crease free form and with minimum tension. In the forming step, the film is heated to 100 to 120° C., preferably approximately 110° C., for up to 5 seconds, preferably approximately 700 micro seconds. A heating plate is used to heat the film, which plate is positioned to superpose the forming die. During this preheating step, a vacuum of 0.5 bar is pulled through the pre-heating plate to ensure intimate contact between the film and the pre-heating plate, this intimate contact ensuring that the film is heated evenly and uniformly (the extent of the vacuum is dependant of the thermoforming conditions and the type of film used, however in the present context a vacuum of less than 0.6 bar was found to be suitable). Non-uniform heating results in a formed package having weak spots. In addition to the vacuum, it is possible to blow air against the film to force it into intimate contact with the preheating plate.

The thermoformed film is moulded into the cavities blowing the film off the heating plate and/or by sucking the film into the cavities thus forming a plurality of recesses in the film which, once formed, are retained in their thermoformed orientation by the application of a vacuum through the walls of the cavities. This vacuum is maintained at least until the packages are sealed. Once the recesses are formed and held in position by the vacuum, a liquid composition according to the invention is added to each of the recesses. A second sheet of polyvinyl alcohol film is then superposed on the first sheet across the filled recesses and heat-sealed thereto using a sealing plate. In this case the heat sealing plate, which is generally flat, operates at a temperature of about 140 to 160° C., and contacts the films for 1 to 2 seconds and with a force of 8 to 30 kg/cm², preferably 10 to 20 kg/cm². The raised flanges surrounding each cavity ensure that the films are sealed together along the flange to form a continuous seal. The rounded edge of each cavity is at least partly formed by a resiliently deformable material, such as for example silicone rubber. This results in reduced force being applied at the inner edge of the sealing flange to avoid heat/pressure damage to the film.

Once sealed, the packages formed are separated from the web of sheet film using cutting means. At this stage it is possible to release the vacuum on the die, and eject the formed packages from the forming die. In this way the packages are formed, filled and sealed while nesting in the forming die. In addition they may be cut while in the forming die as well.

During the forming, filling and sealing steps of the process, the relative humidity of the atmosphere is controlled to ca. 50% humidity. This is done to maintain the heat sealing characteristics of the film. When handling thinner films, it may be necessary to reduce the relative humidity to ensure that the films have a relatively low degree of plasticisation and are therefore stiffer and easier to handle.

(b) Vertical Form-Fill-Seal

In the vertical form-fill-seal (VFFS) technique, a continuous tube of flexible plastics film is extruded. It is sealed, preferably by heat or ultrasonic sealing, at the bottom, filled with the liquid composition, sealed again above the liquid film and then removed from the continuous tube, e.g. by cutting.

Encapsulation methods for other water soluble films such as based on PVP or PEO will be known to those skilled in the art.

Unit Dose Volume

The amount of the substantially non-aqueous liquid cleaning composition is each unit dose envelope may for example be from 10 ml to 100 ml, e.g. from 12.5 ml to 75 ml, preferably from 15 ml to 60 ml, more preferably from 20 ml to 55 ml.

Any reference herein to filling refers to complete filling and also partial filling whereby some air or other gas is also trapped in the sealed envelope.

The Substantially Non-Aqueous Liquid Cleaning Composition

Non-Aqueous Liquid Component

The substantially non-aqueous liquid cleaning composition must contain at least one non-aqueous liquid. Further, the non-aqueous liquid itself and/or another component of the composition must provide a cleaning function when released into the wash liquor.

By “substantially non-aqueous” it is meant that that the amount of water in the liquid composition is below the level at which the package would dissolve through contact with its contents. Preferably, the liquid composition comprises 25%, e.g. no more than 20%, more preferably no more than about 15%, still more preferably no more from 10%, such as no more than about 7%, even more preferably no more than about 5% and most preferably no more than from about 3% to about 4%, by weight water. However, in some cases, it may be possible (whether by reason of the thickness of the film used, the physical properties, such as viscosity, of the liquid composition or otherwise) to use even higher quantities of water in the liquid composition inside the package according to the invention, although these should never exceed 50% by weight of the liquid composition.

The substantially non-aqueous liquid composition may be substantially Newtonion or else non-Newtonion in rheology. The latter especially applies when the composition comprises dispersed solids. Therefore, for the avoidance of doubt, all viscosities expressed herein are measured at a shear rate of 21 s⁻¹.

The viscosity of the composition is preferably from 25 mPaS, 50 mPaS, 75 mPaS or 100 mPaS, preferably 125 mPaS, more preferably 150 mPaS to 10,000 mPaS, for example above 150 mPaS but no more than 10,000 mPaS. The alternative embodiment of the invention relates to VFFS encapsulation in which case, the minimum viscosity must be 10 mPaS, for example above 150 mPaS.

The composition may be considered as falling into the sub-classes of thin liquids, thick liquids, and gels/pastes.

The thin liquids may have a minimum viscosity of 25, 50, 75, 100, 125 ,150 mPaS or above 150 mPaS for example 175 mPaS, preferably 200 mPaS. They may for example have a maximum viscosity of 500 mPaS preferably 450 mPaS more preferably 400 mPaS or even 250 mPaS.

The thick liquids may have a minimum viscosity of 400 mPaS, for example 350 mPaS, or even 300 mPaS and a maximum viscosity of 1,500 mPaS, preferably 1,200 mPaS.

The gels or pastes may have a minimum viscosity of 1,400 mPaS, for example 1,500 mPaS, preferably 1,750 mPaS, 2000 mPaS, 2,500 mPaS, 3,000 mPaS or even 3,500 mPaS. Their maximum viscosity may be 10,000 mPaS, preferably 9,000 mPaS, more preferably 8,000 mPaS, 7,500 mPaS or even 4,000 mPaS.

The non-aqueous liquid may comprise one or more non-aqueous liquid components. These may be one or more liquid surfactants and/or one or more non-aqueous non-surfactant liquids.

Suitable liquid surfactants are liquid nonionic surfactants.

Nonionic detergent surfactants are well-known in the art. They normally consist of a water-solubilizing polyalkoxylene or a mono- or di-alkanolamide group in chemical combination with an organic hydrophobic group derived, for example, from alkylphenols in which the alkyl group contains from about 6 to about 12 carbon atoms, dialkylphenols in which primary, secondary or tertiary aliphatic alcohols (or alkyl-capped derivatives thereof), preferably having from 8 to 20 carbon atoms, monocarboxylic acids having from 10 to about 24 carbon atoms in the alkyl group and polyoxyprbpylense. Also common are fatty acid mono- and dialkanolamides in which the alkyl group of the fatty acid radical contains from 10 to about 20 carbon atoms and the alkyloyl group having from 1 to 3 carbon atoms. In any of the mono- and di-alkanolamide derivatives, optionally, there may be a polyoxyalkylene moiety joining the latter groups and the hydrophobic part of the molecule. In all polyalkoxylene containing surfactants, the polyalkoxylene moiety preferably consists of from 2 to 20 groups of ethylene oxide or of ethylene oxide and propylene oxide groups. Amongst the latter class, particularly preferred are those described in the applicants' published European specification EP-A-225,654, especially for use as all or part of the solvent. Also preferred are those ethoxylated nonionics which are the condensation products of fatty alcohols with from 9 to 15 carbon atoms condensed with from 3 to 11 moles of ethylene oxide. Examples of these are the condensation products of C₁₁₋₁₃ alcohols with (say) 3 or 7 moles of ethylene oxide. These may be used as the sole nonionic surfactants or in combination with those of the described in the last-mentioned European specification, especially as all or part of the solvent.

Another class of suitable nonionics comprise the alkyl polysaccharides (polyglycosides/oligosaccharides) such as described in any of specifications U.S. Pat. Nos. 3,640,998; 3,346,558; 4,223,129; EP-A-92,355; EP-A-99,183; EP 70,074, '75, '76, '77; EP 75,994, '95, '96.

Nonionic detergent surfactants normally have molecular weights of from about 300 to about 11,000. Mixtures of different nonionic detergent surfactants may also be used, provided the mixture is liquid at room temperature.

Suitable non-aqueous non-surfactant liquids forms can be used alone or with in combination with liquid surfactants. Non-surfactant solvents which are more preferred category include ethers, polyethers, alkylamines and fatty amines, (especially di- and tri-alkyl- and/or fatty-N-substituted amines), alkyl (or fatty) amides and mono- and di- N-alkyl substituted derivatives thereof, alkyl (or fatty) carboxylic acid lower alkyl esters, ketones, aldehydes, polyols, and glycerides. Specific examples include respectively, di-alkyl ethers, polyethylene glycols, alkyl ketones (such as acetone) and glyceryl trialkylcarboxylates (such as glyceryl tri-acetate), glycerol, propylene glycol, and sorbitol.

Other suitable solvents are lower (C₁₋₄) alcohols, such as ethanol, or higher (C₅₋₉) alcohols, such as hexanol, as well as alkanes and olefins. However, they can be combined with other solvent materials which are surfactants and non-surfactants having the aforementioned “preferred” kinds of molecular structure. Even though they appear not to play a role in the deflocculation process of dispersed solids, it is often desirable to include them for lowering the viscosity of the product and/or assisting soil removal during cleaning.

Preferably, the compositions of the invention contain the organic solvent (whether or not comprising liquid surfactant) in an amount of at least 10% by weight of the total composition. The amount of the solvent present in the composition may be as high as about 90%, but in most cases the practical amount will lie between 20 and 70% and sometimes, between 20 and 50% by weight of the composition. The weight ratio of surfactant to non-surfactant non-aqueous liquid components is preferably from 0:10 to 10:0, more preferably from 1:10 to 10:1, still more preferably from 1:6 to 6:1, yet more preferably from 1:5 to 5:1, e.g. from 1:3 to 3:1.

Whether or not the composition contains nonionic surfactants, as well as the materal of formula (I), one or more other surfactants may be present. These may be in liquid form or as solid dissolved or dispersed in the substantially non-aqueous liquid component. They may be selected from anionic cationic and ampholytic detergent surfactants. The anionic surfactants may be incorporated in free acid and/or neutralised form. The cationic surfactant may be neutralised with a counter ion or it may be used as stabilising compound to neutralise the at least one ionic ingredient with an exchangeable hydrogen ion.

The composition may also comprise one or more solid dissolved and/or dispersed in the substantially non-aqueous liquid. When these are dispersed solids, it is preferred also to include one or more deflocculating agents as described in EP-A-0 266 199.

Some of these ingredients may be of an acidic nature, such as soaps or the acid precursors of anionic surfactants (which can be used for their surfactant properties and/or as deflocculants). These materials have an exchangeable hydrogen ion. As already mentioned, according to our copending but unpublished application PCT/EP01/03770, when the liquid composition comprises at least one “acidic” component having an exchangeable hydrogen ion, and the film is a PVA film including carboxyl-functional co-monomers, it is preferred to substantially neutralise or over-neutralise this component with a stabilising compound. This is to solve the following problem.

PVOH can be made by the polymerisation of vinyl acetate, followed by hydrolysis, conveniently by reaction with sodium hydroxide. However, the resulting film has a highly symmetrical, hydrogen-bonded structure and is not readily soluble in cold water. PVOH films which are suitable for the formation of water soluble packages are typically polymers produced from copolymerisation of vinyl acetate and another comonomer which contains a carboxylic function. Examples of such comonomers include monocarboxylates, such as acrylic acid, and dicarboxylates, such as itaconic acid, which may be present during polymerisation as esters. Alternatively, the anhydride of maleic acid may be used as the copolymer. The inclusion of the comonomer reduces the symmetry of and degree of hydrogen bonding in the final film and renders the film soluble even in cold water.

However, when the resultant copolymer film contains carboxylic acid or carboxylate groups (either of these hereinafter being referred to as “carboxylate functionality”) in proximity to hydroxyl groups on the same carbon chain and there is an attendant drive towards cyclisation of these groups by water elimination to form lactones. A low level of lactone formation is desirable to improve the mechanical properties of the film. However, the formation of excessive amounts of lactones is undesirable as this tends to reduce the cold water solubility of the film, giving rise to a danger of undissolved film residues when the package is used.

The problem of excessive lactone formation is particularly acute when the liquid composition inside the package comprises ionic species. This is thought to be because the presence of ionic species can give rise to exchange between sodium ions (associated with carboxylate groups) in the film and hydrogen ions in the liquid composition. Once such exchange has occurred, the resulting carboxylic acid group in the film can cyclise with a neighbouring hydroxyl group, eliminating water in the process, thus forming lactones.

Ionic Ingredients with Exchangeable Hydrogen Ions

Ionic ingredient(s) with exchangeable hydrogen ions may, for example, constitute from between 1% and 40% (prior to any neutralisation) by weight of the total substantially non-aqueous liquid composition. If incorporated in unneutralised form (M═H), the material(s) of formula (I) constitute one material with exchangeable hydrogen ions. When used primarily for their surfactant properties, such ingredients may for example be present in amounts greater than 10% by weight. When used as deflocculants (see below), the amounts may be 10% by weight or less, e.g. no more than 5% by weight. These ingredients may for example be selected from anionic surfactant acid precursors and fatty acids and mixtures thereof.

Other anionic surfactant acids are well known to those skilled in the art. Examples suitable for use in a liquid composition according to the invention include alkylbenzene sulphonic acid, particularly C₈₋₁₅ linear alkylbenzene sulphonic acids and mixtures thereof. Other suitable surfactant acids include the acid forms of olefin sulphonates, alkyl ether sulphates, alkyl sulphates or alkane sulphonates and mixtures thereof.

A wide range of fatty acids are suitable for inclusion in a liquid composition according to the invention, for example selected from one or more C₈₋₂₄ alkyl or alkenyl monocarboxylic acids. Saturated or unsaturated fatty acids may be used. Examples of suitable fatty acids include oleic acid, lauric acid or hardened tallow fatty acid.

Stablilising Compound

The provision of a molar excess (with respect to the amount of exchangeable hydrogen ions in the at least one ionic ingredient) of the stabilising compound in the liquid composition is found to have a significant effect in maintaining the cold water solubility of the film through the hindrance of lactone formation. However, in the case of inorganic bases and/or ammonium hydroxide forming all or part of the stabilising compound, the amount of stabilising compound need not be in excess, provided it is at least 95 mole % of the amount needed for full neutralisation. Surprisingly, the hindrance of lactone formation is significantly greater when these amounts of stabilising compound is used than when a molar equivalent or less is used. This advantageous effect is particularly marked after prolonged storage (eg for several weeks) of the package according to the invention at elevated temperature (eg 37° C.), conditions which are frequently encountered by some commercial products in European and other markets.

The problem of excessive lactone formation is particularly acute when the liquid composition inside the package comprises ionic species having an exchangeable hydrogen ion, for example fatty acids or the acid precursors of anionic surfactants.

This problem may be solved by including in the composition, a stabilising compound effective for combining with the exchangeable hydrogen ions to hinder the formation of lactones within the film. This stabilising compound should preferably be in molar excess relative to the component(s) having an exchangeable ion. This molar excess is preferably up to 105 mole %, preferably up to 110 mole % of the stoichiometric amount necessary for complete neutralisation. It is preferably an organic base such as one or more amines, e.g. monoethanolamine, triethanolamine and mixtures thereof. When the stabilising compound is or comprises an inorganic base such as an alkali metal (e.g. sodium or potassium) hydroxide, or ammonium hydroxide, it may, however, present in an amount as low as 95 mole %, eg. from 95 mole % to 105 mole % relative to the component(s) having an exchangeable hydrogen ion.

In other aspects of the invention, for the stabilising compound, instead of the 95 mole %, we may claim as minimum, any of 90, 91, 92, 93, 94, 94.4, 96, 96.5, 97, 97.5, 98, 98.5, 99 and 99.5 mole %. Also, independently of any particular minimum, in other aspects of the invention, as maximum, we may claim any of 100.25, 100.5, 101, 101.5, 102, 102.5, 103, 103.5, 104, 105, 106, 107, 108, 109 and 110 mole%.

Other possible inorganic stabilising compounds are alkaline earth metal hydroxides or other inorganic bases which do liberate water on protonation. These are preferably also used in an amount indicated above for the alkali metal hydroxides and ammonium hydroxide.

Yet other suitable stabilising compounds are amines other than monoethanolamine and triethanolamine, and organic Lewis bases or other organic or inorganic bases provided that they will interact effectively with labile protons within the detergent composition to hinder the production of lactones in the film.

Other Components

The substantially non-aqueous liquid cleaning composition may further comprise one or more ingredients selected from non-ionic or cationic surfactants, builders, polymers, fluorescers, enzymes, silicone foam control agents, perfumes, dyes, bleaches and preservatives.

Some of these materials will be solids which are insoluble in the substantially non-aqueous liquid medium. In that case, they will be dispersed in the substantially non-aqueous liquid medium and may be deflocculated by means of one or more acidic components such as selected from inorganic acids anionic surfactant acid precursors and Lewis acids, as disclosed in EP-A-266 199, as mentioned above.

The invention will now be more particularly described with reference to the following examples.

### EXAMPLE

% by weight

| | 1 | 2 | 3 | 4 |
|---|---|---|---|---|
| C_{2/3} E₅ | 25.0 | 25.0 | 25.0 | 25.0 |
| LAS acid (C₁₀-C₁₄) | 10.0 | 10.0 | 10.0 | 10.0 |
| Monateric EH | 10.0 | — | — | — |
| Detergent Essence | — | 10.0 | — | — |
| Sokalan ES9992X | — | — | 10.0 | — |
| LED3A | — | — | — | 10.0 |
| FA (C₁₂-C₁₈) | 16.0 | 16.0 | 16.0 | 16.0 |
| Glycerol | 20.0 | 20.0 | 20.0 | 20.0 |
| Monopropylene glycol | 7.0 | 7.0 | 7.0 | 7.0 |
| Monoethanolamine | 6.0 | 6.0 | 6.0 | 10.0 |
| Enzymes, Polymer | 2.0 | 2.0 | 2.0 | 2.0 |
| Perfume | 1.0 | 1.0 | 1.0 | 1.0 |

| | |
|---|---|
| Water | balance to 100 |

Controls were compositions corresponding to that of Examples but with all of the surfactants of formula (I) in examples 1 to 3 replaced by 10% LAS acid and 4% monoethanolamine and in example 4 replaced by 10% LAS only.

In this composition the following abbreviations have been used:

Cx/yEz C1x-C1y linear or linear, beta-branched primary alcohol ethoxylate (average z moles of ethoxylate). For example C23E5 is an abbreviation for a mixture of C₁₂ and C₁₃ and an average 5 moles of ethoxylate. (e.g. Neodol 23-5 as obtained from Shell)

LAS acid (Cₓ-C_{y}) (Linear) alkylbenzene sulphonic acid of Cₓ-C_{y} carbon atoms (e.g. with an average carbon chain length between C₁₀ and C₁₄).

Monateric EH Coco amido dipropionate, disodium salt, i.e. C_{12/14}N(CH₂CH₂CO₂Na)₂(ex Uniqema/ICI, UK)

Detergent Essence Coco amido di-ethoxydiacetic acid, disodium salt C_{12/14}—N (EO_{≧n}[CH₂]ₘCO₂H)₂, n ≧3, eg 3 (ex Guangzhou Chemicals, China)

Sokalan ES9992X Cocoyl (C₁₂/C₁₄) Glycine Diacetic Acid, trisodium salt (ex BASF, Germany)

LED3A Lauroyl(C₁₂) Ethylenediaminetetriacetic acid (ex Hampshire Chemicals, UK)

FA (Cₓ-C_{y}) Fatty acid, comprising a mixture of fatty acids of Cₓ-C_{y} carbon atoms, for example derived from nut oil and rich in lauric acid and myristic acid (C12/C14), and/or derived from bean oil or sunflower oil or beef tallow and rich in palmitic acid (C16), stearic acid (C18) and oleic acid (C18:1)

Enzymes Mixture of Protease and Lipase

MEA Monoethanolamine

MPG Monopropyleneglycol

Polymer Soil Release Polymer

The ability of Example 1 and the Control to remove oily soil were evaluated as follows.

The compositions were in all cases dosed at 2.0 g/l. The wash regime was 30 minutes washing in 10 and 50° FH waterhardness.

In a laboratory scale wash evaluation (LWE) simulating a machine wash, examples 1 to 4 were tested for washing performance with cotton and mixed synthetic fabrics soiled with various fatty and oily or sebumacious soils, and with particulate soils.

Results

In all cases replacement of the LAS for 10% of the chelating surfactants showed improved performance at low hardness, but particularly at high hardnesses. The performance improvements were obtained on oily and fatty sebumacious soils and on particulate soils.

1. A water soluble package formed from a water soluble film containing a substantially non-aqueous liquid composition comprising at least one surfactant selected from those of formula (I): 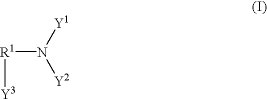
wherein R¹ is a straight or branched C₅-C₂₂ alkyl or C₅-C₂₂ alkenyl group, preferably C₅-C₁₈ alkyl group or C₅-C₁₈ alkenyl group, or a group of formula 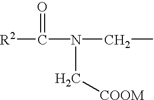
wherein R² is independently selected from groups defined for R¹ above;
Y¹ and Y² are independently selected from groups of formula
—(AO)ₙ—(CH₂)ₘ—CO₂M;
wherein each AO is an independently selected C₂-C₄, preferably C₂ or C₃ alkyleneoxy group, n is on average from 0 to 20, preferably from 0-10, still more preferably from 1 to 3;
m is from 0 to 5, preferably from 1 to 3, preferably n+m being at least 1;
M is a hydrogen ion or a cation, preferably an organic cation or an alkali metal ion; and
Y³ is hydrogen or an independently selected group of formula Y¹ and Y² as hereinbefore defined.

2. A water soluble package according to claim 1, wherein, in formula (I), in both Y¹ and Y², Y³ is hydrogen, n is zero and preferably m is 2.

3. A water soluble package according to claim 1, wherein, in formula (I), in each of Y¹ and Y², Y³ is hydrogen, n is on average 3 or higher and m is 1.

4. A water soluble package according to claim 1, wherein in formula (I), in both Y¹ and Y², n is zero, m is 2 and in Y³, both m and n are zero.

5. A water soluble package according to claim 1, wherein in both Y¹ and Y², n is zero, m is 3, Y³ is hydrogen and R¹ is a group of formula R²CON(CH₂COOM)CH₂—.

6. A water soluble package according to claim 1, wherein the total amount of surfactant of formula (I) is from 0.1% to 80%, preferably from 1% to 60%, more preferably from 2 to 50%, and most preferably from 3% to 40% by weight of the total composition.

7. A water soluble package according to claim 1, wherein the substantially non aqueous liquid composition is substantially free from phosphate and aluminosilicate builders.

8. A water soluble package according to claim 1, wherein the film comprises polyvinyl alcohol.

9. A water soluble package according to claim 8, wherein the film contains a comonomer having carboxylate functionality.

10. A water soluble package according to claim 8, wherein the substantially non-aqueous liquid composition comprises: at least one ionic ingredient with an exchangeable hydrogen ion; and a molar excess (with respect to the amount of exchangeable hydrogen ions in the at least one ionic ingredient) of a stabilising compound effective for combining with the exchangeable hydrogen ions to hinder the formation of lactones, especially β lactones within the film; with the proviso that if the stabilising compound is or comprises an inorganic base and/or ammonium hydroxide then it is present in an amount of at least 95 mole % of the amount to completely neutralise the at least one ionic ingredient.

11. A water soluble package according to claim 1, wherein the liquid composition is a laundry treatment agent.
